(19) United States
(12) Patent Application Publication
(10) Pub. No.: US 2020/0063559 A1
(43) Pub. Date: Feb. 27, 2020

(54) OPPOSED-PISTON ENGINE

(71) Applicant: TOYOTA JIDOSHA KABUSHIKI KAISHA, Toyota-shi (JP)

(72) Inventor: Eiichi KAMIYAMA, Mishima-shi (JP)

(73) Assignee: TOYOTA JIDOSHA KABUSHIKI KAISHA, Toyota-shi (JP)

(21) Appl. No.: 16/449,636

(22) Filed: Jun. 24, 2019

(30) Foreign Application Priority Data
Aug. 22, 2018 (JP) 2018-155300

(51) Int. Cl. F01B 9/04; F01B 9/02; F02B 75/24; F02B 75/00

(52) U.S. Cl. CPC F01B 9/04; F01B 9/026; F16H 21/52; F02B 75/005; F02B 75/24

(57) ABSTRACT

A pair of cylinders (2, 5) are arranged in parallel at the two sides of a crankshaft (8). The cylinders (2, 5) are respectively provided with pairs of pistons (3, 4, 6, 7). The crankshaft (8) has a pair of crankpins (12, 13). The axes of these crankpins (12, 13) are slanted with respect to the axis of the crankshaft (8) in opposite directions. The crankpins (12, 13) have the rocker members (14, 15) attached to them to be able to turn. The tip ends of the arms (16) of the rocker member (14, 15) are connected to the connecting rods (11) of the corresponding pistons (3, 4, 6, 7). If the pistons (3, 4, 6, 7) reciprocate the rocker members (14, 15) engage in swinging motion and the crankshaft (8) rotates.

### FIELD

The present invention relates to an opposed-piston engine.

### BACKGROUND

Known in the art is an opposed-piston engine where a cylinder block is comprised of a pair of cylinder block parts each provided with a cylinder, a piston reciprocating inside the cylinder, and a crankshaft connected to the piston through a connecting rod, the cylinders open to the outside at the outer side surfaces of the corresponding cylinder block parts, the cylinder block parts are joined so that the opening portions of the cylinders are aligned with each other, a combustion chamber is formed between the top surfaces of the pistons reciprocating inside the cylinders, the piston inside one cylinder block part is used to drive rotation of the crankshaft of that one cylinder block part, and the piston inside the other cylinder block part is used to drive rotation of the crankshaft of that other cylinder block part (for example, see Japanese Unexamined Patent Publication No. 2017-193994).

### SUMMARY

### Technical Problem

In this regard, in such an opposed-piston engine, if it were possible to make the overall shape of the engine flatter, it would become possible to easily mount the engine below a floor of a vehicle, so a passenger compartment inside the vehicle could be enlarged. Further, even if the space for mounting the engine were limited like in the case of using the engine as a generator engine in an electric vehicle mounting a large capacity storage battery, if it were possible to flatten the overall shape of the engine, the engine could be easily mounted in the vehicle.

However, if, like in the above-mentioned opposed-piston engine, using a crank mechanism designed to connect tip ends of crank arms extending outside from the crankshaft in the radial direction with the pistons by connecting rods, since the radii of rotation of the crank arms are large, there is the problem that flattening the overall shape of the engine would be difficult. Furthermore, if using the pistons to drive the rotation of separate crankshafts, there would be the problem that a gear mechanism etc. for connecting the crankshafts would become necessary and the engine structure would become complicated.

To solve the above problems, according to the present invention, there is provided an opposed-piston engine comprising:

a cylinder

a first piston and a second piston which are arranged in the cylinder and reciprocate in opposite directions to each other while the top surface of the first piston and the top surface of the second piston face each other,

a combustion chamber formed between a top surface of the first piston and a top surface of the second piston at a center part of the cylinder in an axial direction,

a crankshaft arranged so that an axis of the cylinder and a rotational axis of the crankshaft become parallel to each other separated by a distance, the crankshaft having a first crankpin and a second crankpin which are formed at two sides of a plane which is vertical to the rotational axis of the crankshaft and includes the center part of the cylinder in the axial direction, the axes of the first crankpin and the second crankpin being slanted with respect to the rotational axis of the crankshaft in mutually opposite directions,

a first rocker member rotatably mounted on the first crankpin and having an arm extending toward outside of the first crankpin in a radial direction, and

a second rocker member rotatably mounted on the second crankpin and having an arm extending toward outside of the second crankpin in a radial direction, a tip end part of the arm of the first rocker member being connected to an end part of a connecting rod attached to a back surface of the first piston, a tip end part of the arm of the second rocker member being connected to an end part of a connecting rod attached to a back surface of the second piston, wherein the first rocker member and the second rocker member engage in swinging motions about the first crankpin and the second crankpin without rotating about the first crankpin and the second crankpin respectively when the first piston and the second piston reciprocate, whereby the crankshaft is made to rotate.

### Advantageous Effects of Invention

Only a single crankshaft is used. Therefore, the structure of the engine can be simplified. Further, the thrust loads acting on the crankshaft through the rocker members are cancelled out by each other inside the crankshaft. Therefore, there is no need to provide thrust bearings for receiving the thrust loads of the crankshaft at the engine body. Further, even if providing thrust bearings, it is sufficient to provide small sized thrust bearings able to withstand low loads, so the structure of the engine can be further simplified.

### BRIEF DESCRIPTION OF DRAWINGS

FIG. 1 is a side cross-sectional view of an opposed-piston engine drawn schematically.

FIG. 2 is a perspective view of a crankshaft.

FIG. 3 is a disassembled perspective view for explaining a structure of the connecting part of the end part of the connecting rod and the arm of the rocker member.

FIG. 4 is a perspective view of the end part of the connecting rod and the arm of the rocker member.

FIG. 5 is a vertical cross-sectional view of the connecting part of the end part of the connecting rod and the arm of the rocker member seen along the arrow A of FIG. 4.

FIG. 6 is a perspective view of the piston and crankshaft etc. showing the state when the cylinder block is removed.

FIG. 7 is a perspective view of another embodiment of the connecting rod.

FIG. 8 is a perspective view showing another embodiment of the connecting part of the end part of the connecting rod and the arm of the rocker member.

FIG. 9 is a cross-sectional view of the engine body showing another embodiment.

FIG. 10 is a perspective view of the crankshaft.

FIG. 11 is a perspective view of the piston and crankshaft etc. showing the state when the cylinder block is removed.

FIG. 12 is a front view of the rocker member.

FIG. 13 is a view for explaining the movement of the piston.

FIG. 14 is a view for explaining a firing order.

FIG. 15 is a front view showing another embodiment of the rocker member.

FIG. 16 is a view for explaining a firing order.

### DESCRIPTION OF EMBODIMENTS

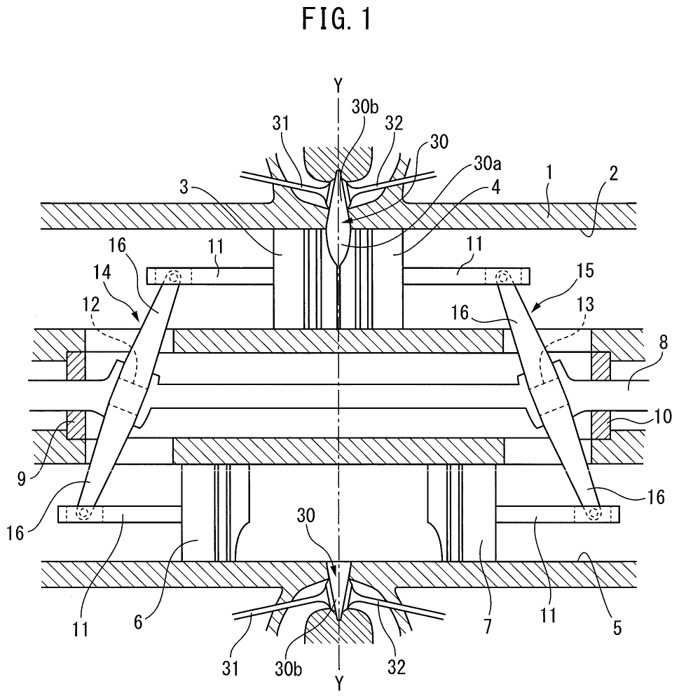

FIG. 1 shows a side cross-sectional view schematically illustrating an embodiment of an opposed-piston engine according to the present invention. Referring to FIG. 1, 1 indicates an engine body, 2 a cylinder formed inside the engine body 1, 3 and 4 a pair of pistons arranged inside the cylinder 2, 5 another cylinder formed inside the engine body 1, 6 and 7 a pair of pistons arranged inside the cylinder 5, and 8 a crankshaft supported inside the engine body 1 to be able to rotate by a pair of bearings 9, 10. As shown in FIG. 1, the cylindrical axes of the cylinders 2 and 5 respectively extend in parallel with the rotational axis of the crankshaft 8 separated by the same distance from the rotational axis of the crankshaft 8.

The pair of pistons 3 and 4 are arranged inside the cylinder 2 so that the pistons 3 and 4 are made to reciprocate in opposite directions from each other while the top surfaces of the pistons 3 and 4 face each other. On the other hand, the pair of pistons 6 and 7 are arranged inside the cylinder 5 so that the pistons 6 and 7 are made to reciprocate in opposite directions from each other while the top surfaces of the pistons 6 and 7 face each other. At the back surfaces of the pistons 3, 4, 6, and 7, connecting rods 11 of the same shapes are attached. The connecting rods 11 attached to the back surfaces of the pistons 3 and 4 are respectively fastened to the back surfaces of the pistons 3 and 4 so as to extend on the axis of the cylinder 2, while the connecting rods 11 attached to the back surfaces of the pistons 6 and 7 are respectively fastened to the back surfaces of the pistons 6 and 7 so as to extend on the axis of the cylinder 5.

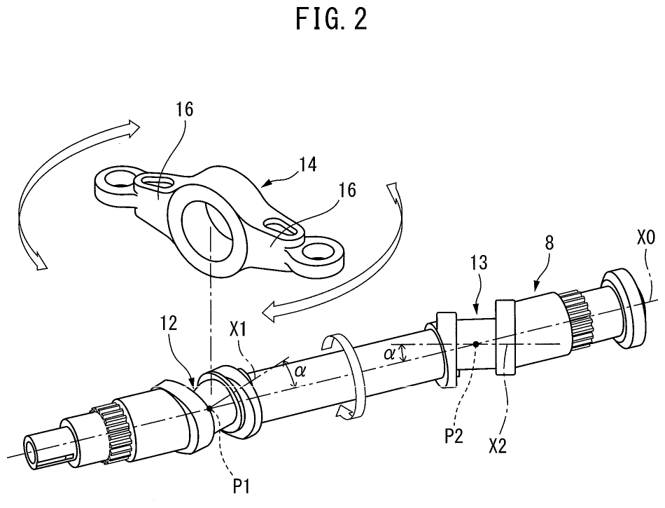

FIG. 2 is a perspective view of the crankshaft 8 shown in FIG. 1. Referring to FIG. 1 and FIG. 2, the crankshaft 8 has a pair of crankpins 12 and 13 formed separated by a distance. Axes of the crankpins 12 and 13 are slanted from the rotational axis of the crankshaft 8 in opposite directions to each other. If explaining this in a bit more detail, as shown in FIG. 2, an axis X1 of the crankpin 12 extends slanted from a rotational axis X0 of the crankshaft 8 and intersects the rotational axis X0 of the crankshaft 8 at a point P1 at the center of the crankpin 12. On the other hand, an axis X2 of the crankpin 13 extends slanted from the rotational axis X0 of the crankshaft 8 in the opposite direction from the axis X1 of the crankpin 12 and intersects the rotational axis X0 of the crankshaft 8 at a point P2 at the center of the crankpin 13. In this case, the rotational axis X0 of the crankshaft 8, the axis X1 of the crankpin 12, and the axis X2 of the crankpin 13 extend in the same plane while the rotational axis X0 of the crankshaft 8 and the axis X1 of the crankpin 12 and also the rotational axis X0 of the crankshaft 8 and the axis X3 of the crankpin 13 intersect by the same intersecting angle α. Therefore, the axes of the crankpins 12 and 13 are slanted in opposite directions to each other with respect to the rotational axis of the crankshaft 8 by the same slant angles α.

On the other hand, as shown in FIG. 1 and FIG. 2, a rocker member 14 is attached to the crankpin 12 to be able to turn, while a rocker member 15 is attached to the crankpin 13 to be able to turn. In this case, the rocker member 14 is attached to be able to turn in the state unable to move in the axial direction of the crankpin 12, while the rocker member 15 is also attached to be able to turn in the state unable to move in the axial direction of the crankpin 13. The rocker member 14 is provided with a pair of arms extending toward the outside from the crankpin 12 in its radial direction to opposite sides. The rocker member 15 is also provided with a pair of arms extending toward the outside from the crankpin 13 in its radial direction to opposite sides. The arms of the rocker member 14 and the arms of the rocker member 15 have the same shapes. Therefore, the arms of these rocker members 14, 15 are shown by the same reference numerals 16.

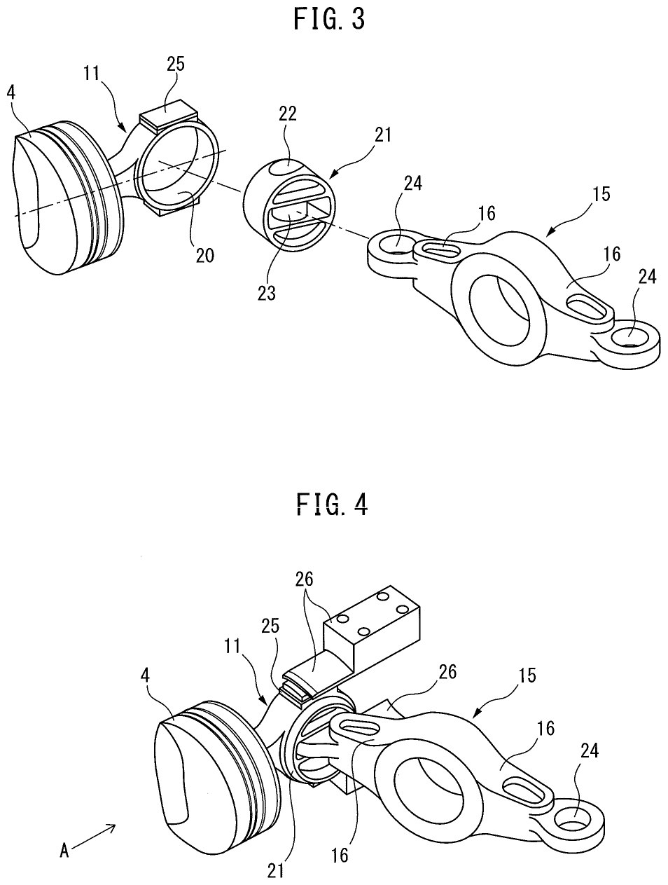

As shown in FIG. 1, the tip end parts of the arms 16 of the rocker member 14 are respectively connected to the end part of the connecting rod 11 of the piston 3 and the end part of the connecting rod 11 of the piston 6, while the tip end parts of the arms 16 of the rocker member 15 are connected to the end part of the connecting rod 11 of the piston 4 and the end part of the connecting rod 11 of the piston 7. The structures of the connecting parts of the tip end parts of the arms 16 and the end parts of the corresponding connecting rods 11 have completely the same connecting structures. Therefore, referring to FIG. 3 to FIG. 5, the structures of the connecting parts of the tip end parts of the arms 16 and the end parts of the corresponding connecting rods 11 will be explained taking as an example the connecting structure between the tip end part of the arm 16 of the rocker member 15 and the end part of the connecting rod 11 of the piston 4.

If referring to FIG. 3 to FIG. 5, the end part of the connecting rod 11 of the piston 4 forms a cylindrical shape. Inside this cylindrically shaped end part, a cylindrical hole 20 is formed. Inside this cylindrical hole 20, a bearing member 21 having a cylindrically shaped outer circumferential surface is fit to enable sliding in the axial direction of the cylindrical hole 20 and enable turning inside the cylindrical hole 20. This bearing member 21 has a through hole 22 running in the diametrical direction of the bearing member 21 through the inside of the bearing member 21. FIG. 3 shows a cylindrical shaft press fit inside this through hole 22 by reference numeral 23. At the tip end part of the arm 16 of the rocker member 15, a cylindrical hole 24 is formed. The tip end part of the arm 16 is inserted into the bearing member 21, then the cylindrical shaft 23 is press fit inside the through hole 22 of the bearing member 21 so as to run through the inside of the cylindrical hole 24 of the arm 16.

If the cylindrical shaft 23 is press fit inside the through hole 22 of the bearing member 21, the tip end part of the arm 16 of the rocker member 15 is connected to the bearing member 21 to be able to turn about the cylindrical shaft 23. At this time, the tip end part of the arm 16 of the rocker member 15 is connected to be able to turn in the state rendered unable to move in the axial direction of the cylindrical shaft 23. FIG. 4 shows when the tip end part of the arm 16 of the rocker member 15 is connected to the bearing member 21 and when the bearing member 21 connected to the arm 16 of the rocker member 15 is fit inside the cylindrical hole 20, that is, when the tip end part of the arm 16 of the rocker member 15 is connected to the end part of the connecting rod 11 of the piston 4. In this way, the tip end parts of the arms 16 of the rocker members 14, 15 are connected to the end parts of the corresponding connecting rods 11 of the pistons 3, 4, 6, 7 to be able to displace in the axial direction of the cylindrical holes 20 and turn inside the cylindrical holes 20 and are connected to be able to turn about the cylindrical shafts 23.

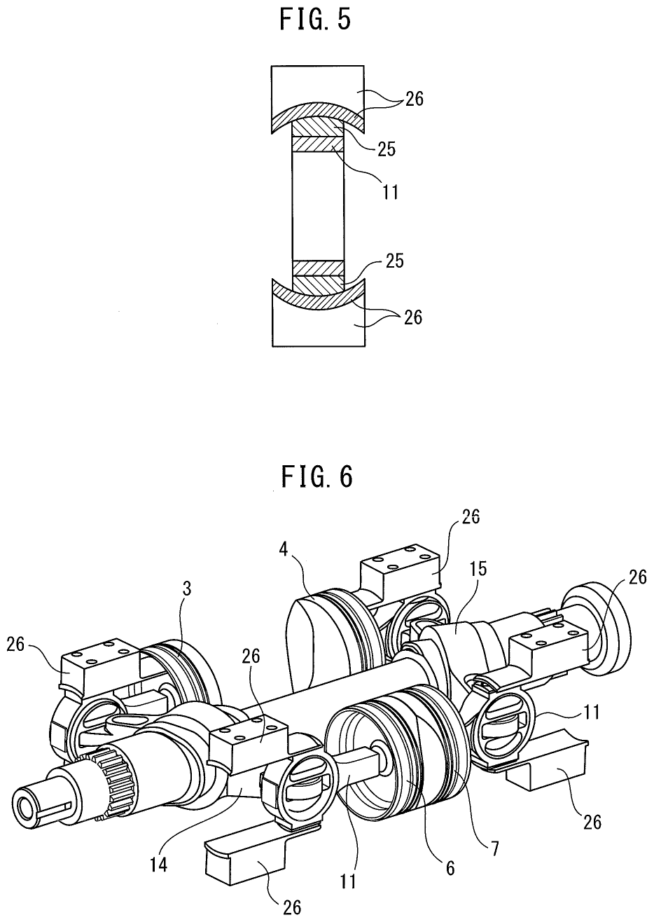

On the other hand, if referring to FIG. 3, FIG. 4, and FIG. 5 showing a vertical cross-sectional view of the connecting part of the end part of the connecting rod 11 and the arm 16 seen along the arrow A of FIG. 4, rectangular shaped sliders 25 are fixed to the upper surface and the lower surface of the cylindrically shaped end part of the connecting rod 11 respectively. As shown in FIG. 5, the cross-sectional shapes of the outside surfaces of the sliders 25 are formed as arc shapes centered about points on the axis of the cylinder 2. On the other hand, above and below the cylindrically shaped end part of the connecting rod 11, connecting rod guides 26 slidingly engaged with the outside surfaces of the sliders 25 are provided. These connecting rod guides 26 have slide guiding surfaces having arc-shaped cross-sections centered about points on the axis of the cylinder 2. The outside surfaces of the sliders 25 slide on the corresponding slide guiding surfaces of the connecting rod guides 26. These connecting rod guides 26 are supported by the engine body 1.

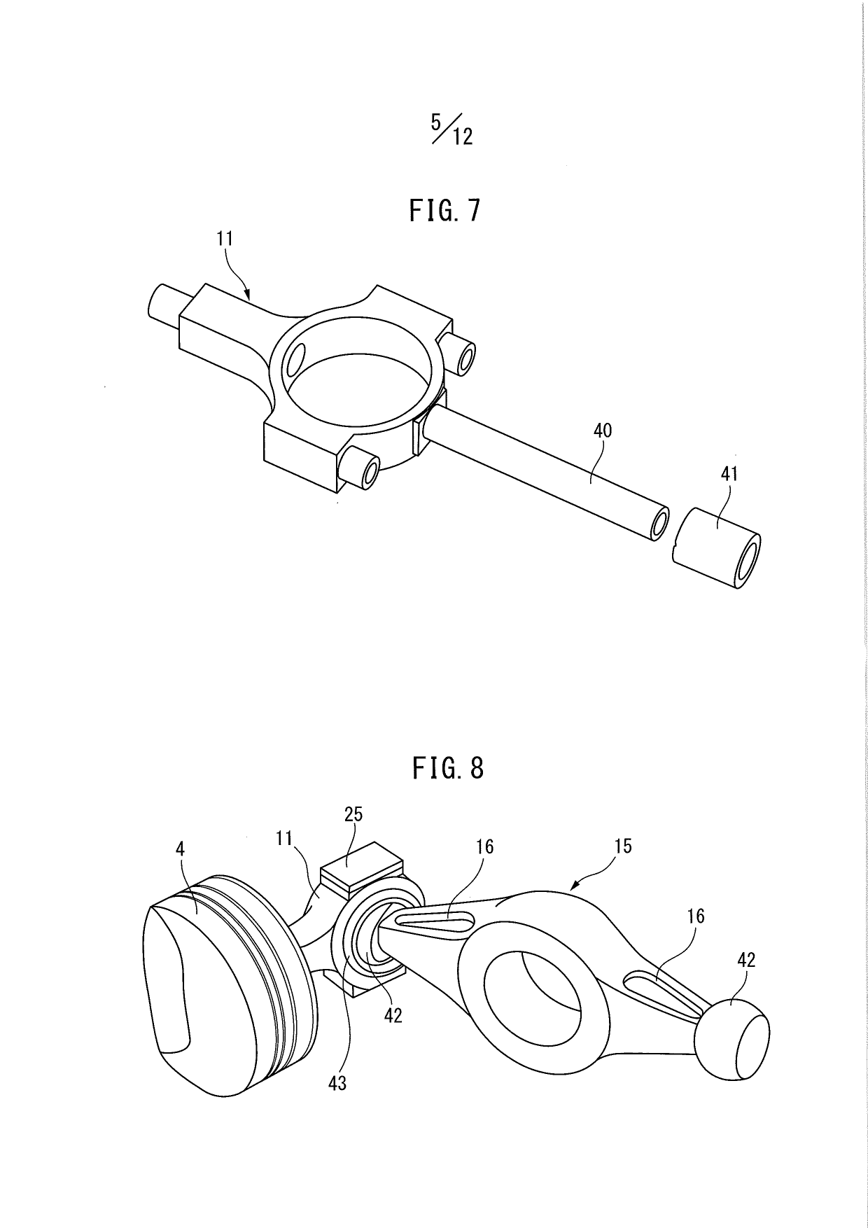

In this way, the cross-sectional shapes of the outside surfaces of the sliders 25 and the slide guiding surfaces of the connecting rod guides 26 are formed to shapes of arcs centered about points on the axis of the cylinder 2. Therefore, the connecting rod 11 is guided by the sliders 25 and connecting rod guides 26 to be able to turn about the axis of the cylinder 2. That is, in the embodiment according to the present invention, the connecting rod guides 26 slidingly engaging with the outer circumferential surfaces of the end parts of the connecting rods 11 of the pistons 3, 4, 6, and 7 are provided so that the connecting rods 11 of the pistons 3, 4, 5, and 6 turn about the axes of the cylinders 2, 5 while being able to reciprocate along the axes of the cylinders 2, 5. By providing such connecting rod guides 26, during operation of the pistons 3, 4, 6, 7, the center axes of the pistons 3, 4, 6, 7 are prevented from becoming slanted with respect to the axes of the cylinders 2, 5. In FIG. 6A, a perspective view of the pistons 3, 4, 6, 7, connecting rods 11, crankshaft 8, and their connecting rod guides 26 is shown.

FIG. 1 shows the time when the pistons 3 and 4 inside the cylinder 2 are at the top dead center positions and a combustion chamber 30 is formed between the top surfaces of the pistons 3 and 4 at the center of the cylinder 2 in the axial direction. As shown in FIG. 1, in the embodiment according to the present invention, the combustion chamber 30 is comprised of a combustion chamber part 30a formed between the top surfaces of the pistons 3 and 4 and a combustion chamber part 30b formed inside the engine body 1. At the combustion chamber part 30b, an intake valve 31, exhaust valve 32, and spark plug (not shown) are arranged. The same is true for the cylinder 5. The engine shown in FIG. 1 is a four-stroke engine. If an air-fuel mixture inside the combustion chamber 30 is ignited by the spark plug, the pistons 3 and 4 separate from each other. Next, when entering an exhaust stroke where the pistons 3 and 4 approach each other, the burned gases are discharged from the exhaust valve 32. Next, when entering an intake stroke where the pistons 3 and 4 separate from each other, the air-fuel mixture is sucked in through the intake valve 31. Next, a compression stroke is entered where the pistons 3 and 4 approach each other.

Now then, if the air-fuel mixture inside the combustion chamber 30 is ignited by the spark plug and the pistons 3 and 4 start to separate from each other, the rocker member 14 is made to rock about the crankpin 12 of the crankshaft 8 by the connecting rod 11 of the piston 3 in the counterclockwise direction in FIG. 1 while the rocker member 15 is made to rock about the crankpin 13 of the crankshaft 8 by the connecting rod 11 of the piston 4 in the clockwise direction in FIG. 1. The combination of the rocker members 14, 15 and the crankpins 12, 13 form a conversion mechanism for converting the rocking motions of the rocker members 14, 15 to rotational motion of the crankshaft 8. Therefore, if the rocker members 14, 15 are made to rock in this way, the crankshaft 8 is made to rotate. In this case, if the pistons 3 and 4 repeat reciprocating motion, as shown by the arrow marks in FIG. 2, the rocker members 14, 15 engage in swinging motion about the corresponding crankpins 12, 13 without rotating about them. Due to this, the crankshaft 8 is made to continuously rotate in one direction as shown by the arrow mark in FIG. 2.

On the other hand, if the air-fuel mixture inside the combustion chamber 30 is ignited by the spark plug and thereby the pistons 3 and 4 start to separate from each other, the rocker members 14, 15 start to turn. At this time, the pistons 6 and 7 inside the cylinder 5 move to approach each other due to the rocker members 14, 15. In this cylinder 5 as well, if the pistons 6 and 7 are positioned at top dead center, a combustion chamber 30 is formed between the top surfaces of the pistons 6 and 7 at the center part of the cylinder 5 in the axial direction. At this time, the pistons 3 and 4 are positioned at bottom dead center. In this case, in the cylinder 5 as well, the pistons 6 and 7 similarly cause repeat of an expansion stroke caused by ignition and combustion, an exhaust stroke, an intake stroke, and a compression stroke. Note that, if the pistons 3 and 4 or the pistons 6 and 7 reciprocate once, the crankshaft 8 turns once. In the engine shown in FIG. 1, each time the crankshaft 8 turns once, the ignition operations are alternately carried out at the cylinder 2 and the cylinder 5 and thereby the combustions of air-fuel mixture are alternately carried out at the cylinder 2 and the cylinder 5.

In the embodiment shown in FIG. 1, the cylinder 2 and the cylinder 5 are arranged at the two sides of the crankshaft 8 so that the center parts of the cylinders 2 and 5 in the axial directions are positioned in the same plane Y vertical to the rotational axis of the crankshaft 8. Further, in the embodiment shown in FIG. 1, the crankpins 12 and 13 are formed on the crankshaft 8 at the two sides of the same plane Y separated by the same distances from the same plane Y. As explained above, in this embodiment according to the present invention, the crankshaft 8 is arranged between the parallel arranged cylinders 2 and 5 so as to extend in parallel to the axes of the two cylinders 2 and 5. Therefore, it becomes possible to flatten the overall shape of the engine body 1. Further, the thrust loads acting on the crankshaft 8 through the rocker members 14, 15 are cancelled out by each other inside the crankshaft 8. Therefore, the engine body 1 does not have to be provided with thrust bearings for bearing the thrust loads of the crankshaft 8. Further, even if providing thrust bearings, it is sufficient to provide small sized thrust bearings able to withstand low loads, so the structure of the engine can be simplified.

FIG. 7 shows another embodiment for guiding the connecting rod 11 so that the connecting rods 11 of the pistons 3, 4, 6, 7 can turn about the axes of the cylinders 2, 5 while reciprocating along the axes of the cylinders 2, 5. In this embodiment, guide rods 40 extending along the axes of the pistons 3, 4, 6, 7 are fixed to the tip ends of the cylindrically shaped end parts of the connecting rods 11, which is separated the most from the pistons 3, 4, 6, and 7. The guide rods 40 are guided to slide by guide members 41 supported by the engine body 1. In this case, in the embodiment shown in FIG. 7, the guide members 41 form hollow cylindrical shapes and the guide rods 40 slide while turning inside the guide members 41.

FIG. 8 shows another embodiment of the connecting part between the end part of the connecting rod 11 and the arm 16 shown in FIG. 4. In this embodiment, as shown in FIG. 8, a spherical part 42 is provided at the tip end part of the arm 16 of the rocker member 15. On the other hand, at the inside of the cylindrically shaped end part of the connecting rod 11, a hollow cylindrically shaped bearing 43 is fit. The spherical part 42 formed at the tip end part of the arm 16 is made to fit inside the bearing 43 to be able to turn and slide.

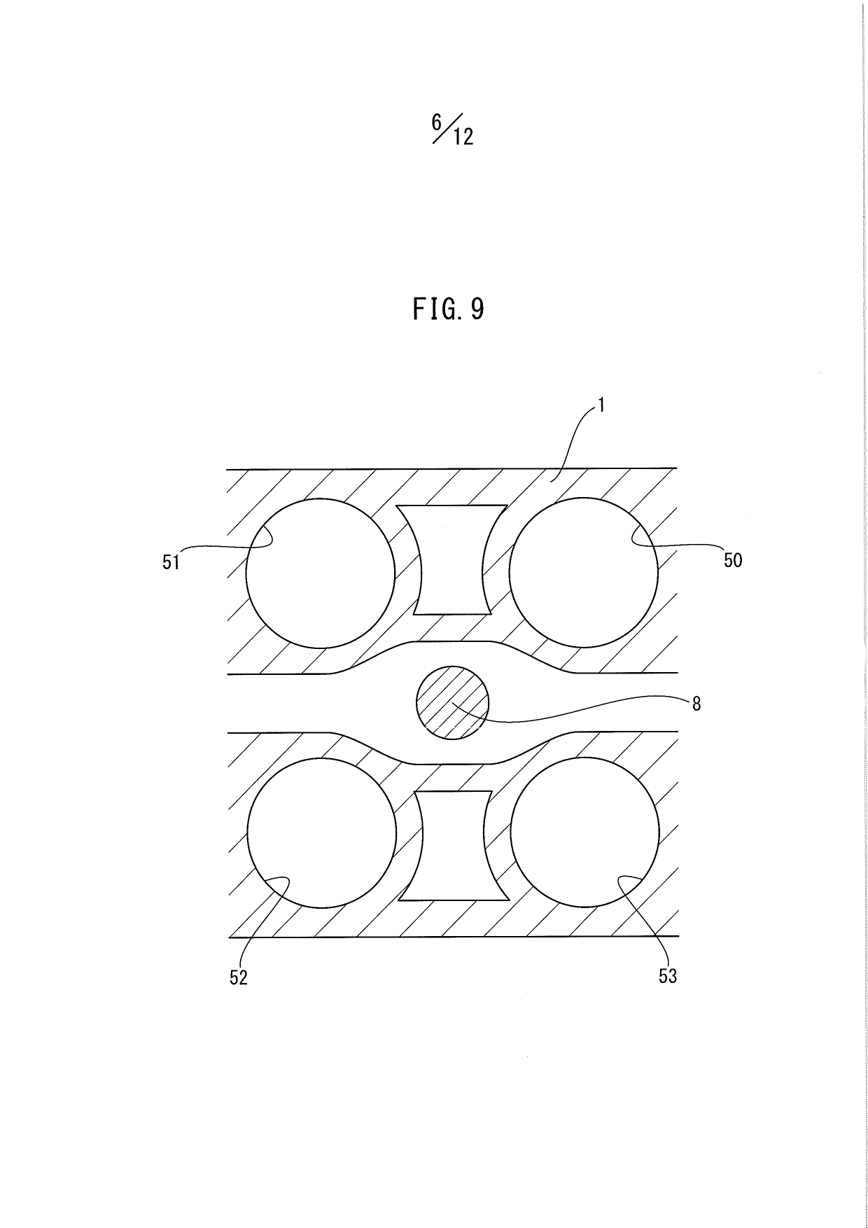

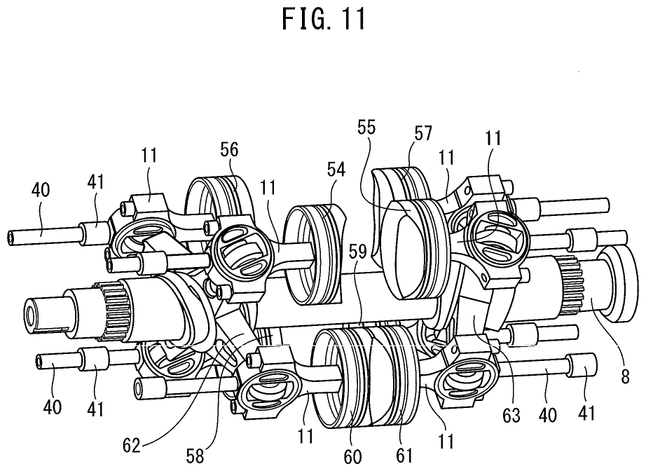

Next, referring to FIG. 9 to FIG. 11, the case where the present invention is applied to an engine having four cylinders will be explained. FIG. 9 shows a side cross-sectional view schematically illustrating an engine having four cylinders. Referring to FIG. 9 and FIG. 11, 1 shows an engine body, 50, 51, 52, and 53 show cylinders formed in the engine body 1, 54 and 55 show a pair of pistons arranged inside the cylinder 50, 56 and 57 show a pair of pistons arranged inside the cylinder 51, 58 and 59 show a pair of pistons arranged inside the cylinder 52, and 60 and 61 show a pair of pistons arranged inside the cylinder 53.

Note that, in the embodiment shown in FIG. 9 to FIG. 11, component elements similar to the component elements shown from FIG. 1 to FIG. 8 are used. For the component elements similar to the component elements shown in FIG. 1 to FIG. 8, reference numerals the same as the reference numerals used in FIG. 1 to FIG. 8 are used. For example, in the embodiment shown from FIG. 9 to FIG. 11, a crankshaft the same as the crankshaft shown in FIG. 2 is used. Therefore, in the embodiment shown in FIG. 9 to FIG. 11, the crankshaft is shown by reference numeral 8. Further, in the embodiment shown in FIG. 9 to FIG. 11, connecting rods 11 of the same structure shown in FIG. 7 are used for all of the pistons 54 to 61. Therefore, in the embodiment shown in FIG. 9 to FIG. 11, all of the connecting rods are shown by the reference numeral 11. Furthermore, in the embodiment shown in FIG. 9 to FIG. 11, arms the same as the arms 16 of the rocker members 14, 15 shown in FIG. 2 to FIG. 4 are used. Therefore, in the embodiment shown in FIG. 9 to FIG. 11, the arms are shown by reference numeral 16.

As will be understood from FIG. 9 and FIG. 11, the cylindrical axes of the cylinders 50, 51, 52, and 53 respectively extend in parallel to the rotational axis of the crankshaft 8 separated by the same distances from the rotational axis of the crankshaft 8. As will be understood from FIG. 9, the cylinders 50, 51, 52, and 53 are arranged at equiangular intervals about the crankshaft 8. In this embodiment as well, the pair of pistons 54, 55 are arranged inside the cylinder 50 so that the pistons 54, 55 are made to reciprocate in opposite directions to each other while the top surfaces of the pistons 54, 55 face each other, the pair of pistons 56, 57 are arranged inside the cylinder 51 so that the pistons 56, 57 are made to reciprocate in opposite directions to each other while the top surfaces of the pistons 56, 57 face each other, the pair of pistons 58, 59 are arranged inside the cylinder 52 so that the pistons 58, 59 are made to reciprocate in opposite directions to each other while the top surfaces of the pistons 58, 59 face each other, and the pair of pistons 60, 61 are arranged inside the cylinder 53 so that t the pistons 60, 61 are made to reciprocate in opposite directions to each other while the top surfaces of the pistons 60, 61 face each other. Note that, in the embodiment shown from FIG. 9 to FIG. 11 as well, combustion chambers provided with intake valves, exhaust valves, and spark plugs such as shown in FIG. 1 are formed at the cylinders 50, 51, 52, and 53.

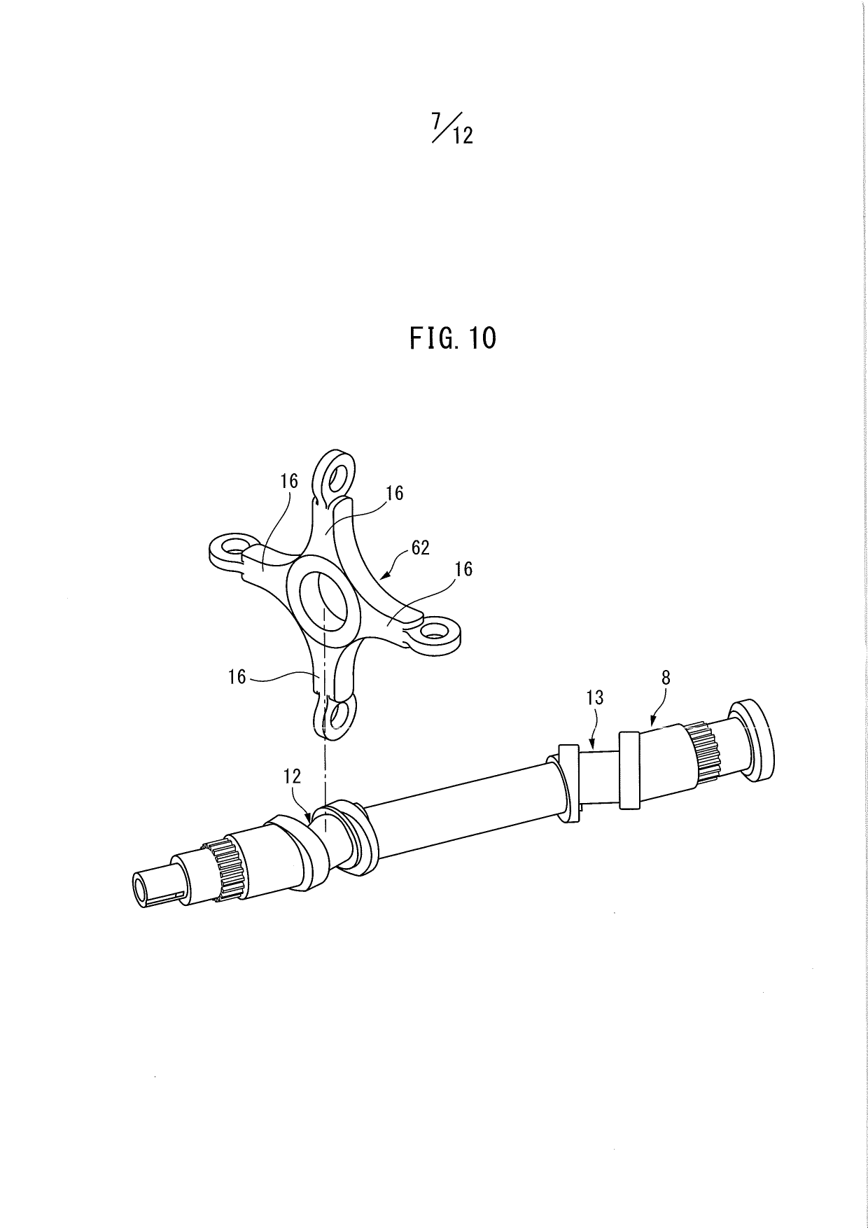

At the back surfaces of the pistons 54 to 61, connecting rods 11 of the same shapes as shown in FIG. 7 are attached. The connecting rods 11 attached to the back surfaces of the pistons 54 to 61 are fastened on the back surfaces of the pistons 54 to 61 so that they extend along the axes of the corresponding cylinders 50, 51, 52, and 53. At the tip ends of the cylindrically shaped end parts of the connecting rods 11, the guide rods 40 are fastened. The guide rods 40 are guided to slide by the guide members 41 supported by the engine body 1. On the other hand, as shown in FIG. 10 and FIG. 11, a rocker member 62 is attached to the crankpin 12 of the crankshaft 8 to be able to turn, while a rocker member 63 is attached to the crankpin 13 of the crankshaft 8 to be able to turn. In this case, the rocker member 62 is attached to be able to turn in a state rendered unable to move in the axial direction of the crankpin 12, while the rocker member 63 is attached to be able to turn in a state rendered unable to move in the axial direction of the crankpin 13.

As shown in FIG. 10, the rocker member 62 is provided with four arms 16 extending outside from the crankpin 12 in the radial direction. The rocker member 63, like the rocker member 62, is provided with four arms 16 extending outside from the crankpin 13 in the radial direction. That is, the rocker members 62, 63 are respectively provided with four arms 16 extending in cross-shapes when viewed along the axes of the crankpins 12, 13. The tip end parts of the arms 16 of the rocker member 62 are respectively connected to the end parts of the connecting rods 11 of the corresponding pistons 54, 56, 58, 60, while the tip end parts of the arms 16 of the rocker member 63 are respectively connected to the end parts of the connecting rods 11 of the corresponding pistons 55, 57, 59, 61. For the structures of the connecting parts of the tip end parts of the arms 16 and the end parts of the connecting rods 11, connecting structures shown in FIG. 3 and FIG. 4 are used. However, in the embodiment shown in FIG. 9 to FIG. 11, the tip end parts of the arms 16 are connected to the cylindrical shafts 23 to be able to turn in a state rendered able to move inside the bearing members 21 in the axial direction of the cylindrical shafts 23.

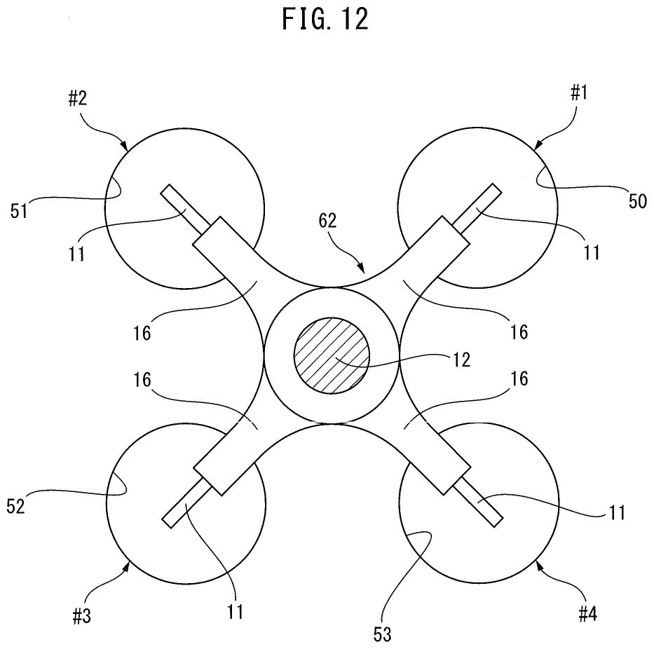

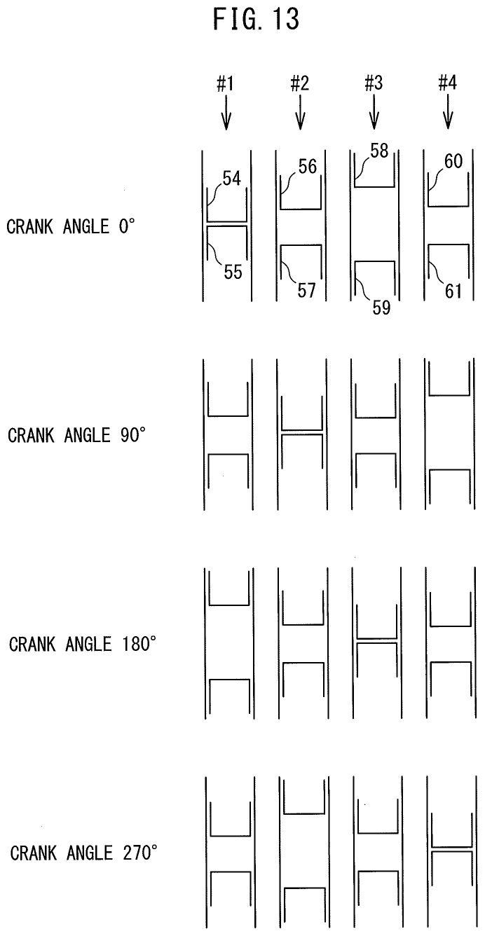

FIG. 12 schematically shows the relationship between the cylinders 50, 51, 52, 53 arranged such as shown in FIG. 9 and the rocker member 62 attached to the crankshaft 8. In FIG. 12, if referring to the cylinders 50, 51, 52, 53 respectively as the No. 1 cylinder #1, the No. 2 cylinder #2, the No. 3 cylinder #3, and the No. 4 cylinder #4, in the embodiment shown in FIG. 9 to FIG. 11, as shown in FIG. 13, the pistons of the corresponding cylinders reach top dead center every 90 degrees of crank angle in the order of the No. 1 cylinder #1, the No. 2 cylinder #2, the No. 3 cylinder #3, and the No. 4 cylinder #4. In this case, if the pistons 54 to 61 repeatedly engage in reciprocating motion, the rocker members 62, 63 engage in swinging motion about the corresponding crankpins 12, 13 without rotating about them. Due to that, the crankshaft 8 is made to rotate continuously in one direction.

In the embodiment shown from FIG. 9 to FIG. 11, the cylinders 50, 51, 52, and 53 are arranged about the crankshaft 8 so that the center parts of the cylinders 50, 51, 52, and 53 in the axial direction are positioned in the same plane vertical to the rotational axis of the crankshaft 8. Further, in the embodiment shown in FIG. 10, the crankpins 12 and 13 are formed on the crankshaft 8 at the two sides of this same plane separated by the same distances from this same plane. In this embodiment as well, as will be understood from FIG. 9, by arranging the cylinders 50, 51, 52, and 53 about the crankshaft 8, it is possible to make the overall shape of the engine body 1 relatively flat.

In this way, in the embodiment shown in FIG. 1 to FIG. 8 and in the embodiment shown in FIG. 9 to FIG. 11, a pair of pistons are arranged inside a single cylinder so that the pistons are made to reciprocate in opposite directions to each other while the top surfaces of the pistons face each other, a combustion chamber is formed between the top surfaces of the pistons at the center part of the cylinder in the axial direction, and the pistons are connected to a crankshaft through connecting rods attached to the back surfaces of the pistons. A plurality of cylinders respectively having pairs of pistons are provided. The cylinders are arranged around the crankshaft so that the axes of the cylinders and the axis of the crankshaft are parallel to each other separated by the same distances and so that the center parts of the cylinders in the axial directions are positioned in the same plane vertical to the rotational axis of the crankshaft. The crankshaft has a pair of crankpins formed at the two sides of this same plane. The axes of the crankpins are slanted from the rotational axis of the crankshaft in mutually opposite directions. At the crankpins, rocker members provided with pluralities of arms extending outward from the crankpins in the radial direction are attached to be able to turn. The tip end parts of the arms of one rocker member are connected with the end parts of the corresponding connecting rods of the pistons positioned at one side from the center parts of the cylinders in the axial direction, while the tip end parts of the arms of other rocker member are connected with the end parts of the corresponding connecting rods of the pistons positioned at the other side from the center parts of the cylinders in the axial direction. When the pistons reciprocate, the rocker members engage in swinging motion about the crankpins without rotating, whereby the crankshaft is made to rotate.

Note that, the present invention can also be applied to an engine having a single cylinder. If expressed comprehensively so as to include an engine having a single cylinder in this way, in the present invention, a pair of pistons are arranged in a single cylinder so that the pistons are made to reciprocate in opposite directions to each other while the top surfaces of the pistons face each other, a combustion chamber is formed between the top surfaces of the pistons at the center part of the cylinder in the axial direction, and the pistons are connected to a crankshaft through connecting rods attached to the back surfaces of the pistons. The cylinder and the crankshaft are arranged so that the axis of the cylinder and a rotational axis of the crankshaft become parallel to each other separated by distances from each other. The crankshaft has a pair of crankpins formed at two sides of a plane which is vertical to the rotational axis of the crankshaft and includes a center part of the cylinder in the axial direction. The axes of the crankpins are slanted from the rotational axis of the crankshaft in mutually opposite directions. The crankpins respectively have rocker members provided with an arm extending toward the outsides of the crankpins in the radial direction attached to be able to turn. The tip end part of the arm of one rocker member is connected to the end part of the connecting rod of the piston positioned at one side from the center part of the cylinder in the axial direction, while the tip end part of the arm of the other rocker member is connected to the end part of the connecting rod of the piston positioned at the other side from the center part of the cylinder in the axial direction. The rocker members engage in swinging motion about the crankpins without rotating about them when the pistons reciprocate, whereby the crankshaft is made to rotate.

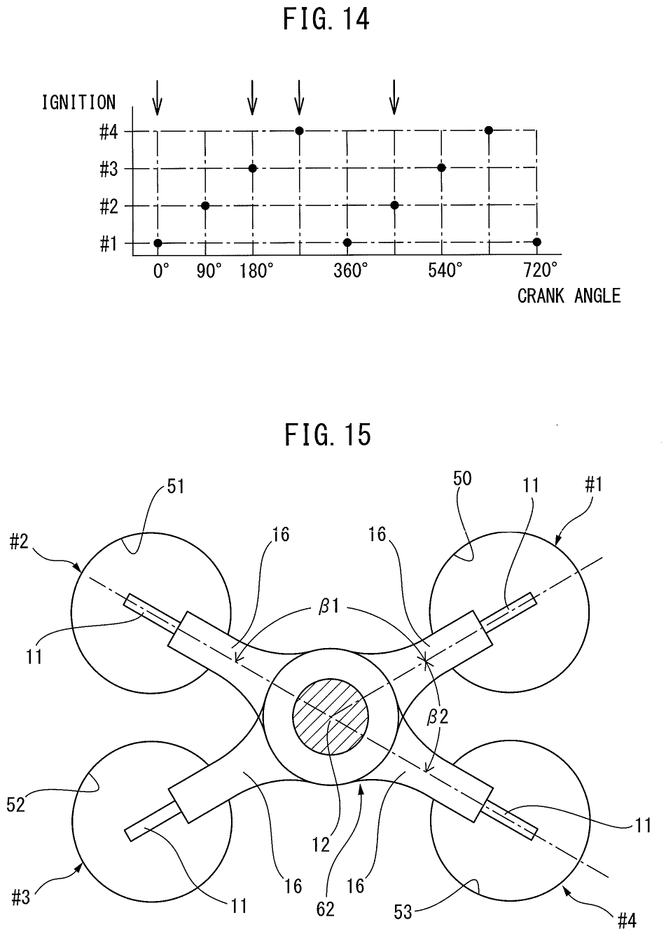

FIG. 14 shows by black dots the crank angles when the pistons of the No. 1 cylinder #1, the No. 2 cylinder #2, the No. 3 cylinder #3, and the No. 4 cylinder #4 become the top dead center positions in FIG. 13. Note that, FIG. 14 shows the crank angle when the piston of the No. 1 cylinder #1 becomes the top dead center position as 0 degree. From FIG. 14, it will be understood that the pistons of the corresponding cylinders reach top dead center with each 90 degrees (crank angle) in the order of the No. 1 cylinder #1, the No. 2 cylinder #2, the No. 3 cylinder #3, and the No. 4 cylinder #4. That is, in the embodiment shown from FIG. 9 to FIG. 13, as will be understood from FIG. 12, the rocker members 62, 63 are respectively provided with four arms 16 connected to the end parts of the corresponding connecting rods 11, and the pistons are successively positioned at top dead center in the order of arrangement around the crankshaft 8 in the circumferential direction.

Now that, in a four-cylinder four-cycle engine, the ignition operations are performed four times in 720 degrees (crank angle). In this case, it is preferable to ignite the air-fuel mixture at as even intervals as possible. Therefore, in a four-cylinder four-cycle engine provided with four cylinders, it becomes preferable to ignite the air-fuel mixture at intervals of 180 degrees (crank angle). However, if, like in the present invention, using rocker members 62, 63 engaging in swinging motion so as to convert the linear motion of the pistons to rotational motion of the crankshaft 8, it is not always possible to ignite the air-fuel mixture at intervals of 180 degrees (crank angle). Therefore, in the embodiment from FIG. 9 to FIG. 13, as will be understood from the arrow marks (showing the ignition timings) in FIG. 14, for example, the ignition operation is performed at the No. 1 cylinder #1, then the ignition operation is performed at the No. 3 cylinder #3 180 degrees (crank angle) away. After the ignition operation is performed at the No. 3 cylinder #3, the ignition operations are performed at the remaining No. 2 cylinder #2 and No. 4 cylinder #4 when the pistons are positioned at top dead center.

In this case, in the example shown in FIG. 14, the ignition operation is performed at the No. 4 cylinder #4 when the crank angle is 270 degrees while the ignition operation is performed at the No. 2 cylinder #2 when the crank angle is 450 degrees, but it is also possible that the ignition operation be performed at the No. 3 cylinder #3, then the ignition operation be performed at the No. 2 cylinder #2 when the crank angle is 450 degrees and the ignition operation be performed at the No. 4 cylinder #4 when the crank angle is 630 degrees. In each case, the case where the ignition interval becomes 90 degrees (crank angle) occurs once while the case where the ignition interval becomes 270 degrees (crank angle) occurs once, but in each case, the ignition operation is performed at the most even intervals.

In this way, in the embodiment shown in FIG. 9 to FIG. 13, the engine is comprised of a four-cycle engine provided with four cylinders 50, 51, 52, 53. In this embodiment, the rocker members 62, 63 are respectively provided with four arms 16 connected to the end parts of the corresponding connecting rods 11. The pistons are successively positioned at top dead center in accordance with the order of arrangement in the circumferential direction about the crankshaft 8. Furthermore, in this embodiment, the ignition operation is performed at a certain cylinder, then the next ignition operation is performed at the cylinder where the piston becomes top dead center after 180 degrees (crank angle). After that, the ignition operation is performed at the remaining two cylinders.

FIG. 15 shows a modification of the embodiment shown in FIG. 9 to FIG. 13. Note that, this FIG. 15, like FIG. 12, schematically shows the relationship among the cylinders 50, 51, 52, 53 and the rocker member 62 attached to crankshaft 8. In FIG. 15, if referring to the cylinder 50 as the No. 1 cylinder, referring to the cylinder 51 as the No. 2 cylinder, referring to the cylinder 52 as the No. 3 cylinder, and referring to the cylinder 53 as the No. 4 cylinder, that is, if referring to the four cylinders as the No. 1 cylinder 50, the No. 2 cylinder 51, the No. 3 cylinder 52, and the No. 4 cylinder 53 in accordance with the order of arrangement in the circumferential direction about the crankshaft 8, the No. 1 cylinder 50 and the No. 3 cylinder 52 are arranged at opposite sides to each other with respect to the crankshaft 8 while the No. 2 cylinder 51 and the No. 4 cylinder 53 are arranged at opposite sides to each other with respect to the crankshaft 8. In this case, in this modification, the angle 131 between the No. 1 cylinder 50 and the No. 2 cylinder 51 about the crankshaft 8 and the angle 131 between the No. 3 cylinder 52 and the No. 4 cylinder 53 about the crankshaft 8 are made larger than the angle 132 between the No. 1 cylinder 50 and the No. 4 cylinder 53 about the crankshaft 8 and the angle 132 between the No. 2 cylinder 51 and the No. 3 cylinder 52 about the crankshaft 8.

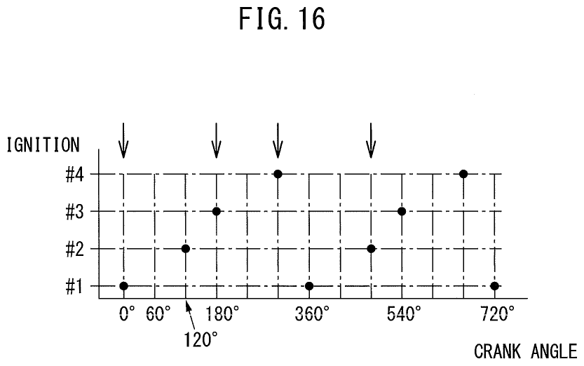

If arranging the cylinders 50, 51, 52, 53 as shown in FIG. 15, the angle between the arm 16 extending toward the No. 1 cylinder 50 and the arm 16 extending toward the No. 2 cylinder 51 also becomes β1 and the angle between the arm 16 extending toward the No. 1 cylinder 50 and the arm 16 extending toward the No. 4 cylinder 53 also becomes β2. That is, the angle β1 between the arm 16 extending toward the No. 1 cylinder 50 and the arm 16 extending toward the No. 2 cylinder 51 becomes larger than the angle β2 between the arm 16 extending toward the No. 1 cylinder 50 and the arm 16 extending toward the No. 4 cylinder 53. If in this way changing the angle between the arms 16 as shown by β1 and β2 in FIG. 15, it is possible to further perform the ignition operations at more closer to even intervals. Next, this will be explained while referring to FIG. 16.

FIG. 16 shows the crank angles when the pistons of the No. 1 cylinder 50, the No. 2 cylinder 51, the No. 3 cylinder 52, and the No. 4 cylinder 53 become the top dead center positions in FIG. 15, that is, the crank angles when the pistons of the No. 1 cylinder #1, the No. 2 cylinder #2, the No. 3 cylinder #3, and the No. 4 cylinder #4 become the top dead center positions in FIG. 15, by black dots. Note that, in this case as well, the crank angle when the piston of the No. 1 cylinder #1 becomes the top dead center position is shown as 0 degree. Furthermore, FIG. 16 shows the ignition timing by arrow marks. Note that, this FIG. 16 shows the case where the angle β1 between the arms 16 is made 120 degrees and the angle β2 between the arms 16 is made 60 degrees. In this case, it will be learned that the piston of the No. 2 cylinder #2 reaches top dead center when the crank angle is 120 degrees, the piston of the No. 3 cylinder #3 reaches top dead center when the crank angle is 180 degrees, and the piston of the No. 4 cylinder #4 reaches top dead center when the crank angle is 300 degrees.

In this modification as well, as will be understood from the arrows in FIG. 16, for example, the ignition operation is performed at the No. 1 cylinder #1, then the ignition operation is performed at the No. 3 cylinder #3 separated by 180 degrees (crank angle). After the ignition operation is performed at the No. 3 cylinder #3, the ignition operation is performed at the remaining No. 2 cylinder #2 and No. 4 cylinder #4 when the piston is positioned at top dead center. In this case, in the example shown in FIG. 16, the ignition operation is performed at the No. 4 cylinder #4 when the crank angle is 300 degrees while the ignition operation is performed at the No. 2 cylinder #2 when the crank angle is 480 degrees. In this case as well, the ignition operation can be performed at the No. 3 cylinder #3, then the ignition operation performed at the No. 2 cylinder #2 when the crank angle is 480 degrees and the ignition operation performed at the No. 4 cylinder #4 when the crank angle is 660 degrees. In either case, a case where the ignition interval becomes 120 degrees (crank angle) occurs once while a case where the ignition interval becomes 240 degrees (crank angle) occurs once.

On the other hand, as explained above, in the case shown in FIG. 14, a case where the ignition interval becomes 90 degrees (crank angle) occurs once while a case where the ignition interval becomes 270 degrees (crank angle) occurs once. Therefore, in the case shown in FIG. 16, compared with the case shown in FIG. 14, the minimum ignition interval becomes larger from 90 degrees to 120 degrees and the maximum ignition interval becomes smaller from 270 degrees to 240 degrees, so the ignition operations can be performed at closer to even intervals. Further, in the case shown in FIG. 15, compared with the case shown in FIG. 14, there is also the advantage that it is possible to flatten the overall shape of the engine body 1.

1. An opposed-piston engine comprising:
a cylinder
a first piston and a second piston which are arranged in the cylinder and reciprocate in opposite directions to each other while a top surface of the first piston and a top surface of the second piston face each other,
a combustion chamber formed between the top surface of the first piston and the top surface of the second piston at a center part of the cylinder in an axial direction,
a crankshaft arranged so that an axis of the cylinder and a rotational axis of the crankshaft become parallel to each other separated by a distance, the crankshaft having a first crankpin and a second crankpin which are formed at two sides of a plane which is vertical to the rotational axis of the crankshaft and includes the center part of the cylinder in the axial direction, the axes of the first crankpin and the second crankpin being slanted with respect to the rotational axis of the crankshaft in mutually opposite directions,
a first rocker member rotatably mounted on the first crankpin and having an arm extending toward outside of the first crankpin in a radial direction, and
a second rocker member rotatably mounted on the second crankpin and having an arm extending toward outside of the second crankpin in a radial direction, a tip end part of the arm of the first rocker member being connected to an end part of a connecting rod attached to a back surface of the first piston, a tip end part of the arm of the second rocker member being connected to an end part of a connecting rod attached to a back surface of the second piston, wherein the first rocker member and the second rocker member engage in swinging motions about the first crankpin and the second crankpin without rotating about the first crankpin and the second crankpin respectively when the first piston and the second piston reciprocate, whereby the crankshaft is made to rotate.

2. The opposed-piston engine according to claim 1, wherein the engine comprises a plurality of the cylinders each having said first piston and said second piston, and the cylinders are arranged about the crankshaft so that the axes of the cylinders and the axis of the crankshaft are parallel with each other separated by the same distances and so that the center parts of the cylinders in the axial direction are positioned in the same plane vertical to the rotational axis of the crankshaft, said first rocker member having a plurality of arms extending toward outside of the first crankpin in a radial direction, said second rocker member having a plurality of arms extending toward outside of the second crankpin in a radial direction, tip end parts of the arms of the first rocker member being connected to end parts of the corresponding connecting rods of the first pistons positioned at one sides from the center parts of the cylinders in the axial direction, tip end parts of the arms of the second rocker member being connected to end parts of the corresponding connecting rods of the second pistons positioned at the other sides from the center parts of the cylinders in the axial direction.

3. The opposed-piston engine according to claim 2, wherein the cylinders are arranged at equiangular intervals about the crankshaft.

4. The opposed-piston engine according to claim 1, wherein connecting rod guides are provided which slidingly engage with outer circumferential surfaces of end parts of the connecting rods of the pistons so that the connecting rods of the pistons can turn about the axis of the cylinder while reciprocating along the cylindrical axis.

5. The opposed-piston engine according to claim 1, wherein guide rods extending along axes of the pistons are fastened to tip ends of end parts of the connecting rods, which are the most separated from the pistons, and the guide rods are guided to slide by guide members supported by the engine body.

6. The opposed-piston engine according to claim 1, wherein the engine is comprised of a four cycle engine provided with four cylinders each having said first piston and said second piston, the first rocker member and the second rocker member are respectively provided with four arms connected to end parts of corresponding connecting rods, the pistons are successively positioned at top dead center in accordance with the order of arrangement in the circumferential direction around the crankshaft, and after an ignition operation is performed at a certain cylinder, the next ignition operation is performed at the cylinder at which the piston reaches top dead center after 180 degrees (crank angle), then the ignition operation is performed at the remaining two cylinders.

7. The opposed-piston engine according to claim 6, wherein four cylinders are arranged at equiangular intervals about the crankshaft and the first rocker member and the second rocker member are respectively are provided with four arms extending in cross shapes when viewed along the axes of the corresponding crankpins.

8. The opposed-piston engine according to claim 6, wherein the four cylinders are comprised of No. 1 cylinder, No. 2 cylinder, No. 3 cylinder, and No. 4 cylinder successively arranged along the circumferential direction around the crankshaft, the No. 1 cylinder and the No. 3 cylinder are arranged at opposite sides from each other with respect to the crankshaft while the No. 2 cylinder and the No. 4 cylinder are arranged at opposite sides from each other with respect to the crankshaft, the angle between the No. 1 cylinder and the No. 2 cylinder around the crankshaft and the angle between the No. 3 cylinder and the No. 4 cylinder around the crankshaft are made larger than the angle between the No. 1 cylinder and the No. 4 cylinder around the crankshaft and the angle between the No. 2 cylinder and the No. 3 cylinder around the crankshaft.
